(19) United States
(12) Patent Application Publication
(10) Pub. No.: US 2025/0264824 A1
(43) Pub. Date: Aug. 21, 2025

(54) COLOR IMAGE FORMING APPARATUS

(71) Applicant: Masatoshi MURAKAMI, Kanagawa (JP)

(72) Inventor: Masatoshi MURAKAMI, Kanagawa (JP)

(73) Assignee: Ricoh Company, Ltd., Tokyo (JP)

(21) Appl. No.: 19/039,264

(22) Filed: Jan. 28, 2025

(30) Foreign Application Priority Data
Feb. 15, 2024 (JP) 2024-021555

(51) Int. Cl. G03G 15/01; G03G 15/00; G03G 15/041

(52) U.S. Cl. CPC G03G 15/011; G03G 15/0189; G03G 15/0415; G03G 15/5016

(57) ABSTRACT

A color image forming apparatus includes a photoconductor on which an image is formed; an optical writing device to expose the photoconductor with light, the optical writing device including: a light emitter to emit light; a deflector including a multifaceted reflector rotationally driven to deflect the light emitted from the light emitter to scan the photoconductor with the light in a scanning direction; a synchronization detector to detect a write start timing of the light to be irradiated onto the photoconductor from the deflector; circuitry configured to: control the light emitter to emit light; and correct a detection shift of the synchronization detector generated by a fluctuation of a light amount of the light incident on the synchronization detector; and adjust the write start timing to correct a color shift.

### CROSS-REFERENCE TO RELATED APPLICATIONS

This patent application is based on and claims priority pursuant to 35 U.S.C. § 119 (a) to Japanese Patent Application No. 2024-021555, filed on Feb. 15, 2024, in the Japan Patent Office, the entire disclosure of which is hereby incorporated by reference herein.

### BACKGROUND

### Technical Field

The present embodiment relates to a color image forming apparatus.

### Related Art

In an electrophotographic image forming apparatus, in particular, in a configuration in which a photoconductor is exposed by a laser diode (LD), when a beam output from the LD is reflected with a polygon mirror that rotates, and the beam of the LD is irradiated from one end to the other end of one surface of the polygon mirror, the beam (laser beam) is deflected according to an angle of the polygon mirror, and the photoconductor is scanned for one line. At this time, by switching on or off the LD according to image data to be input, an electrostatic latent image for one line can be formed on the photoconductor, and by repeating line scanning while rotating the photoconductor, an electrostatic latent image of a desired image can be formed.

When the line scanning is repeated, it is necessary to match a write start timing to start image formation. In order to decide the write start timing, a light detection sensor is provided immediately before the photoconductor is scanned, and a scanning position of the beam is detected. The light detection sensor is expressed as a synchronization detection sensor, and the write start timing of the image data is determined according to an output signal of the synchronization detection sensor.

The light detection sensor includes a photodiode, and detects a minute current change using an amplifier and a gain resistance. The light detection sensor can determine the presence or absence of a beam input by the current change. Although the light detection sensor can form a circuit by combining elements, a photo IC including a slit and a cover glass to improve and stabilize detection accuracy is commercially available and can be used at low cost.

A light amount of the beam is changed according to an image formation condition. The image formation condition includes a change in productivity (linear velocity), a change in temperature environment, and the like in addition to a change in resolution of an output image. When the image formation condition is changed, the light amount of the beam input to the synchronization detection sensor is also changed. When the light amount of the beam changes, the magnitude of the current flowing through the light detection sensor changes, and a detection waveform of the light detection sensor changes. When the detection waveform of the light detection sensor changes, the write start timing of the image data is shifted to generate a positional shift in a scanning direction (main scanning direction).

Since the positional shift described above is about several 10 ns at most, if it is a single color like a monochrome machine, it will not be a problem, but in a color machine, a change in color tone or color shift occurs, and image quality is deteriorated.

### SUMMARY

In an aspect of the present disclosure, a color image forming apparatus is provided that includes: a photoconductor on which an image is formed; an optical writing device to exposes the photoconductor with light, the optical writing device including: a light emitter to emit light; a deflector including a multifaceted reflector rotationally driven to deflect the light emitted from the light emitter to scan the photoconductor with the light in a scanning direction; a synchronization detector to detect a write start timing of the light to be irradiated onto the photoconductor from the deflector; circuitry configured to: control the light emitter to emit light; correct a detection shift of the synchronization detector generated by a fluctuation of a light amount of the light incident on the synchronization detector; and adjust the write start timing to correct a color shift; a memory to store: an execution result including a first light amount of the light emitter to correct the color shift; a detection-shift characteristic value indicating a characteristic of the detection shift. The circuitry is further configured to: calculate a detection-shift correction value to correct the detection shift based on: the first light amount; a second light amount of the light emitter as a lighting condition; and the detection-shift characteristic value; and add the detection-shift correction value to a color-shift correction value to adjust the write start timing; update the detection-shift characteristic value stored in the memory.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a diagram illustrating an example of a configuration of a color image forming apparatus according to the present embodiment;

FIG. 1B is a diagram illustrating an example of a hardware configuration of a multi-function peripheral/product/printer (MFP) to which the color image forming apparatus according to the present embodiment is applied;

FIG. 2 is a functional block diagram of an example of an optical writing device included in the color image forming apparatus according to the present embodiment;

FIG. 3 is a diagram for explaining an example of a correction function of a write start timing in the color image forming apparatus according to the present embodiment;

FIG. 4 is a diagram illustrating an example of a synchronization detection plate in the color image forming apparatus according to the present embodiment;

FIG. 5 is a diagram illustrating an example of a configuration of an optical writing device of the color image forming apparatus according to the present embodiment;

FIG. 6 is a diagram illustrating an example of a detection signal and an output signal of a beam of a light detection sensor of the color image forming apparatus according to the present embodiment;

FIG. 7 is a diagram illustrating an example of a relationship between a light amount of a beam with which a light detection sensor of the color image forming apparatus according to the present embodiment is irradiated, and a detection signal and an output signal;

FIG. 8 is a diagram illustrating another example of the configuration of the optical writing device of the color image forming apparatus according to the present embodiment;

FIG. 9 is a diagram illustrating an example of a detection signal and an output signal of a beam of a light detection sensor of the color image forming apparatus according to the present embodiment;

FIG. 10 is a diagram illustrating an example of a detection signal and an output signal of a beam of a light detection sensor of the color image forming apparatus according to the present embodiment;

FIG. 11 is a diagram illustrating an example of a change in a write start timing of the color image forming apparatus according to the present embodiment;

FIGS. 12A and 12B are diagrams illustrating an example of a detection-shift characteristic table in the color image forming apparatus according to the present embodiment;

FIG. 13 is a diagram for explaining an example of a method of using a detection-shift characteristic table in the color image forming apparatus according to the present embodiment;

FIG. 14 is a diagram for explaining an example of a method of correcting the write start timing in a case where a detection-shift characteristic curve of an Nth-order polynomial is used instead of the detection-shift characteristic table in the color image forming apparatus according to the present embodiment;

FIG. 15 is a diagram for explaining an example of updating of a detection-shift characteristic table or a detection-shift characteristic curve in accordance with characteristics of the optical writing device in the color image forming apparatus according to the present embodiment;

FIG. 16 is a diagram for explaining an example of processing of updating a detection-shift characteristic table or a detection-shift characteristic curve in the color image forming apparatus according to the present embodiment;

FIGS. 17A and 17B are diagrams for explaining an example of details of a method of updating a detection-shift characteristic table in the color image forming apparatus according to the present embodiment;

FIG. 18 is a diagram for explaining an example of details of a method of updating a detection-shift characteristic curve in the color image forming apparatus according to the present embodiment;

FIG. 19 is a flowchart illustrating an example of a flow of color matching processing in the color image forming apparatus according to the present embodiment; and

FIG. 20 is a flowchart illustrating an example of a flow of a printing operation in the color image forming apparatus according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of a color image forming apparatus will be described in detail with reference to the accompanying drawings.

### First Embodiment

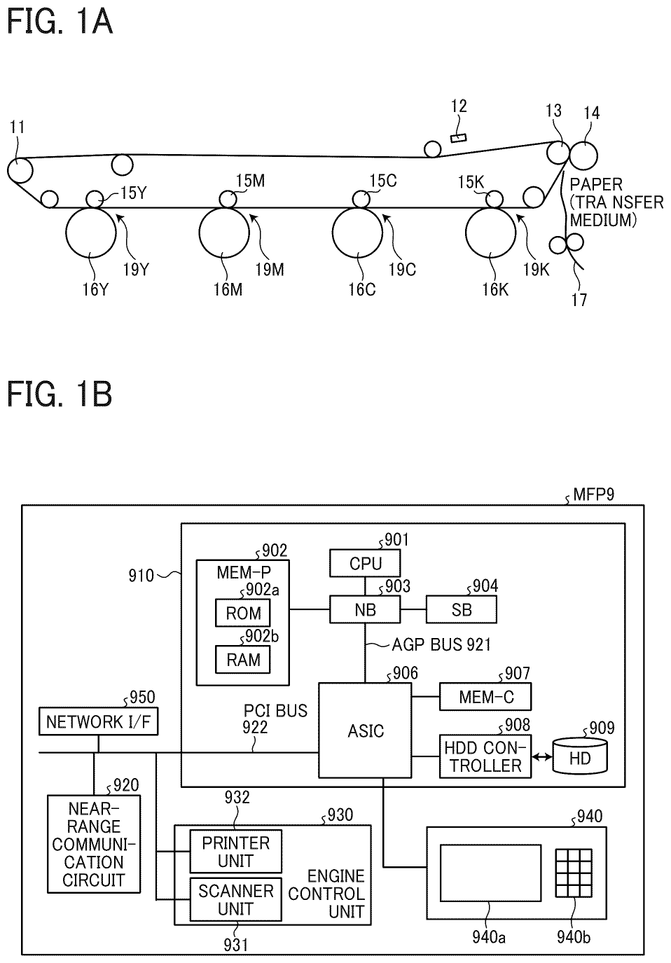

FIG. 1A is a diagram illustrating an example of a configuration of a color image forming apparatus according to the present embodiment. The color image forming apparatus is an example of an electrophotographic color image forming apparatus that forms an image by developing an electrostatic latent image formed on a photoconductor with a developer and forms the image on a recording sheet conveyed by a registration roller or the like.

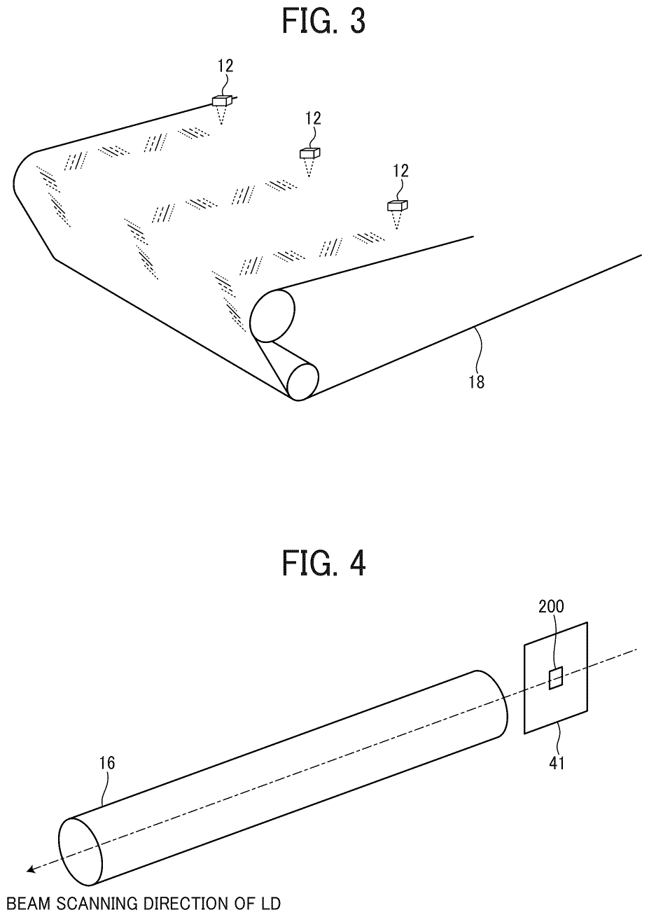

As illustrated in FIG. 1A, the color image forming apparatus according to the present embodiment includes primary transfer rollers 15K, 15C, 15M, and 15Y, photoconductors 16K, 16C, 16M, and 16Y (Hereinafter, the photoconductors 16K, 16C, 16M, and 16Y are also referred to as photoconductors 16 in the case of not being distinguished from one another), an intermediate transfer belt 18 (see FIG. 3), a tension roller 11, a TM/P sensor 12, a driving roller 13, and a secondary transfer roller 14. In the following description, in a case where the primary transfer rollers 15K, 15C, 15M, and 15Y are not distinguished, they are referred to as primary transfer rollers 15.

The photoconductors 16K, 16C, 16M, and 16Y are arranged along the intermediate transfer belt 18 in the order of the photoconductors 16Y, 16M, 16C, and 16K from the upstream side in a conveyance direction of the intermediate transfer belt 18.

A charger, a developing device, the primary transfer roller 15K, a photoconductor cleaner, a static eliminator, and the like are disposed around the photoconductor 16K. In the following description, the photoconductor 16K, the charger, the developing device, the primary transfer roller 15K, the photoconductor cleaner, the static eliminator, and the like are collectively referred to as image forming unit 19K.

Note that, in all of the photoconductors 16C, 16M, and 16Y, components common to the photoconductor 16K are arranged around the photoconductors. In the following description, the photoconductor 16C, the charger, the developing device, the primary transfer roller 15C, the photoconductor cleaner, the static eliminator, and the like are collectively referred to as image forming unit 19C. The photoconductor 16M, the charger, the developing device, the primary transfer roller 15M, the photoconductor cleaner, the static eliminator, and the like are collectively referred to as image forming unit 19M. The photoconductor 16Y, the charger, the developing device, the primary transfer roller 15Y, the photoconductor cleaner, the static eliminator, and the like are collectively referred to as image forming unit 19Y.

In the present embodiment, in a case where color image formation is performed, the photoconductors 16K, 16C, 16M, and 16Y abut on the intermediate transfer belt 18, and in a case where monochrome image formation is performed, the photoconductor 16K abuts on the intermediate transfer belt 18, and the photoconductors 16C, 16M, and 16Y are separated from the intermediate transfer belt 18.

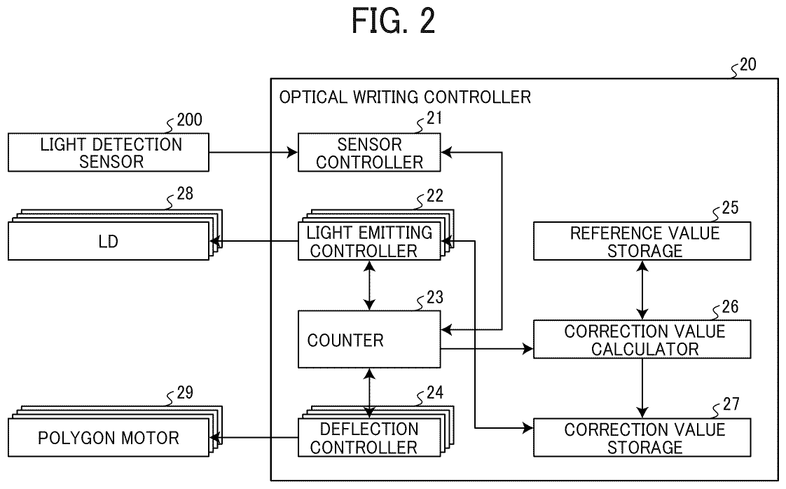

Then, an image forming unit 19K and a laser diode (LD 28) (see FIG. 2) form a black toner image on the intermediate transfer belt 18 by performing an image forming process (charging step, exposure step, developing step, transfer step, cleaning step, and static elimination step) in a state where the photoconductor 16K is in contact with the intermediate transfer belt 18. The LD 28 is an example of a light emitter that irradiates the photoconductor 16 with light (beam).

Similarly, an image forming unit 19C and the LD 28 form a cyan toner image on the intermediate transfer belt 18 by performing an image forming process in a state where the photoconductor 16C is in contact with the intermediate transfer belt 18. An image forming unit 19M and the LD 28 form a magenta toner image on the intermediate transfer belt 18 by performing an image forming process in a state where the photoconductor 16M is in contact with the intermediate transfer belt 18. An image forming unit 19Y and the LD 28 form a yellow toner image on the intermediate transfer belt 18 by performing an image forming process in a state where the photoconductor 16Y is in contact with the intermediate transfer belt 18.

That is, in the present embodiment, in the case of forming a color image, the photoconductors 16K, 16C, 16M, and 16Y perform an image forming process. Furthermore, in the present embodiment, in a case where a monochrome image is formed, the photoconductor 16K performs an image forming process, but the photoconductors 16C, 16M, and 16Y do not perform an image forming process.

Hereinafter, the image forming process by the image forming unit 19K will be mainly described, and the description of the image forming process by the image forming units 19C, 19M, and 19Y will be omitted.

The photoconductor 16K is rotationally driven by a drive motor.

First, in the charging step, the charger uniformly charges the outer peripheral surface of the rotationally driven photoconductor 16K in the dark.

Subsequently, in the exposure step, the LD 28 exposes the outer peripheral surface of the rotationally driven photoconductor 16K with a beam to form an electrostatic latent image based on a black image on the photoconductor 16K.

Subsequently, in the developing step, the developing device develops the electrostatic latent image formed on the photoconductor 16K with black toner, and forms a black toner image on the photoconductor 16K.

Subsequently, in the transfer step, the primary transfer roller 15K transfers the black toner image formed on the photoconductor 16K to the intermediate transfer belt 18 at a primary transfer position in contact with the photoconductor 16K. Note that the toner not transferred slightly remains on the photoconductor 16K even after the toner image is transferred.

Subsequently, in the cleaning step, the photoconductor cleaner wipes the toner not transferred remaining on the photoconductor 16K.

Finally, in the static elimination step, the static eliminator eliminates the residual potential on the photoconductor 16K. Then, the photoconductor 16K waits for the next image formation.

The intermediate transfer belt 18 is an endless belt wound around the tension roller 11 and the driving roller 13, and moves endlessly in the order of the photoconductors 16K, 16C, 16M, and 16Y when the driving roller 13 is rotationally driven by a driving motor.

As illustrated in FIG. 1A, in a case where color image formation is performed, first, a yellow toner image is transferred to the intermediate transfer belt 18 by the photoconductor 16Y, subsequently, a magenta toner image is transferred by the photoconductor 16M, a cyan toner image is transferred by the photoconductor 16C, and a black toner image is transferred by the photoconductor 16K. As a result, the toner images of the respective colors are superimposed on the intermediate transfer belt 18 to form a full-color image.

Furthermore, in a case where monochrome image formation is performed, a black toner image is transferred to the intermediate transfer belt 18 by the photoconductor 16K. As a result, a monochrome image is formed on the intermediate transfer belt 18.

Then, when the image formed on the intermediate transfer belt 18 is conveyed to the secondary transfer position in contact with the driving roller 13, the secondary transfer roller 14 presses the recording sheet conveyed by a registration roller 17 or the like against the image formed on the intermediate transfer belt 18 at the secondary transfer position. As a result, the image is transferred from the intermediate transfer belt 18 to the recording sheet.

The tension roller 11 applies tension to the intermediate transfer belt 18 to absorb all the extension of the intermediate transfer belt 18 due to the influence of temperature change. That is, in the present embodiment, the intermediate transfer belt 18 does not uniformly extend due to the influence of the temperature change, but the extension of the intermediate transfer belt 18 due to the influence of the temperature change is concentrated on a portion of the tension roller 11.

Here, in the present embodiment, the tension roller 11 is disposed on the path from the TM/P sensor 12 to the primary transfer position on the most upstream side (the primary transfer position at which the photoconductor 16Y and the primary transfer roller 15Y are in contact) of the intermediate transfer belt 18.

The TM/P sensor 12 is a photosensor or the like, and reads a color matching pattern formed on the intermediate transfer belt 18. In the present embodiment, as illustrated in FIG. 1A, in a case where color image formation is performed, color matching patterns of four colors are formed on the intermediate transfer belt 18 by the photoconductors 16K, 16C, 16M, and 16Y.

FIG. 1B is a diagram illustrating an example of a hardware configuration of an MFP to which the color image forming apparatus according to the present embodiment is applied. As illustrated in FIG. 1B, an MFP9 includes a controller 910, a near-range communication circuit 920, an engine controller 930, an operation panel 940, and a network I/F 950.

Among these, the controller 910 includes a CPU 901 which is a main part of a computer, a system memory (MEM-P 902), a north bridge (NB) 903, a south bridge (SB) 904, an application specific integrated circuit (ASIC 906), a local memory (MEM-C 907) which is a memory, an HDD controller 908, and an HD 909 which is a memory, and the NB 903 and the ASIC 906 are connected by an accelerated graphics port bus (AGP bus 921).

Among these, the CPU 901 is a controller that performs overall control of the MFP9. The NB 903 is a bridge for connecting the CPU 901, the MEM-P 902, the SB 904, and the AGP bus 921, and includes a memory controller that controls reading and writing from and to the MEM-P 902, a peripheral component interconnect (PCI) master, and an AGP target.

The MEM-P 902 includes a ROM 902a which is a memory for storing a program and data for realizing each function of the controller 910, and a RAM 902b which is used as a drawing memory or the like at the time of developing the program and the data and printing the memory. Note that the program stored in the RAM 902b may be provided by being recorded in a computer-readable recording medium such as a compact disk (CD)-ROM, a CD-recordable (CD-R), and a digital versatile disk (DVD) as a file in an installable format or an executable format.

The SB 904 is a bridge for connecting the NB 903 to a PCI device and a peripheral device. The ASIC 906 is an integrated circuit (IC) for image processing having a hardware element for image processing, and serves as a bridge that connects the AGP bus 921, a PCI bus 922, the HDD controller 908, and the MEM-C 907. The ASIC 906 includes a PCI target, an AGP master, an arbiter (ARB) that forms the core of the ASIC 906, a memory controller that controls the MEM-C 907, multiple direct memory access controllers (DMAC) that rotates image data by hardware logic or the like, and a PCI unit that performs data transfer between a scanner unit 931 and a printer unit 932 via the PCI bus 922. Note that an interface of a universal serial bus (USB) or an interface of Institute of Electrical and Electronics Engineers 1394 (IEEE 1394) may be connected to the ASIC 906. In the present embodiment, the printer unit 932 has a configuration of a color image forming apparatus illustrated in FIG. 1A.

The MEM-C 907 is a local memory used as a copy image buffer and a code buffer. The HD 909 is a storage for accumulating image data, accumulating font data used at the time of printing, and accumulating forms. The HD 909 controls reading or writing of data from/to the HD 909 under the control of the CPU 901. The AGP bus 921 is a bus interface for a graphics accelerator card proposed for speeding up graphics processing, and can speed up the graphics accelerator card by directly accessing the MEM-P 902 with high throughput.

The near-range communication circuit 920 is a communication circuit such as near field communication (NFC) or Bluetooth (registered trademark). Furthermore, the engine controller 930 includes the scanner unit 931 and the printer unit 932. Furthermore, the operation panel 940 includes a panel display unit 940a such as a touch panel that displays a current setting value, a selection screen, and the like and receives an input from an operator, and an operation panel 940b including a numeric keypad that receives a setting value of a condition related to image formation such as a density setting condition, a start key that receives a copy start instruction, and the like. The controller 910 controls the entire MFP9, and controls, for example, drawing, communication, input from the operation panel 940, and the like. The scanner unit 931 or the printer unit 932 includes an image processing portion such as error diffusion and gamma conversion.

Note that the MFP9 can sequentially switch and select the document box function, the copy function, the printer function, and the facsimile function by the application switching key of the operation panel 940. A document box mode is set when the document box function is selected, a copy mode is set when the copy function is selected, a printer mode is set when the printer function is selected, and a facsimile mode is set when the facsimile mode is selected.

Furthermore, the network I/F 950 is an interface for performing data communication using a communication network 100. The near-range communication circuit 920 and the network I/F 950 are electrically connected to the ASIC 906 via the PCI bus 922.

FIG. 2 is a functional block diagram of an example of an optical writing device included in the color image forming apparatus according to the present embodiment. As illustrated in FIG. 2, the optical writing device according to the present embodiment is an example of an optical writing device that includes an optical writing controller 20, a light detection sensor 200, an LD 28, a polygon motor 29, and the like and exposes the photoconductors 16.

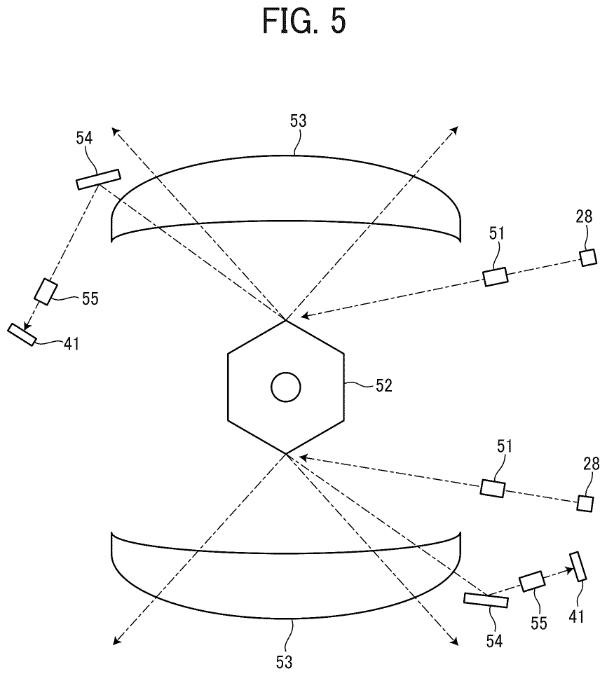

The light detection sensor 200 is an example of a synchronization detector that detects the write start timing of the electrostatic latent image by irradiating the photoconductors 16 with light. A light emitting controller 22 of the optical writing controller 20 is an example of a light emitting control element that controls light emission of the LDs 28, and has functions of controlling turning on and off of the LDs 28 and adjusting the light amount of the LDs 28. In order to form an electrostatic latent image on the photoconductors 16, the light emitting controller 22 transfers a turn-on signal and a turn-off signal of the LD 28 corresponding to input image data at a targeted timing. Hereinafter, the timing of starting the transfer of the turn-on signal and the turn-off signal of the LD 28 is referred to as a write start timing. Furthermore, the light emitting controller 22 may control the light amount of the LD 28 to be constant while the beam irradiated from one end to the other end of one surface of a polygon mirror 52 (see FIG. 5) scans in one direction. The light emitting controller 22 may have a function of fluctuating the light amount of the LDs 28 at a specific timing in the scanning direction. However, in order to reduce the manufacturing cost, the light emission controller may not have such a configuration but to have a uniform light amount in the entire scanning period as in the present embodiment. The light detection sensor 200 detects the beam output from the LD 28 in order to decide the write start timing. The output signal of the light detection sensor 200 is input to the optical writing controller 20, and resets the internal count value counted by a counter 23. The internal count value during the image formation is automatically counted up, and when the internal count value reaches a predetermined value, the transfer of the turn-on signal and the turn-off signal of the LD 28 according to the image data is started.

The above-described predetermined value is a value determined by a sum of a reference value determined on the basis of the arrangement of the photoconductors 16 and the arrangement of the light detection sensor 200 and a correction value (color-shift correction value) of a shift in the scanning direction of each color. The color-shift correction value in the main scanning direction is stored in a correction value storage 27, and is read from the correction value storage 27 before image formation is started. The correction value storage 27 is an example of a memory that stores the execution result of the color-shift correction, the color-shift correction value, and the detection-shift characteristic value in association with each other. The RAM 902b may be used for the correction value storage 27. Here, the execution result of the color-shift correction includes the light amount (an example of the first light amount) of the LD 28 when the color shift is corrected.

A correction value calculator 26 (an example of a color-shift correction function unit) corrects the color shift by adjusting a write start timing from when the light detection sensor 200 detects the beam to when the light emission control by the light emitting controller 22 according to the image data is started. The correction value calculator 26 decides the write start timing using the color-shift correction value read from the correction value storage 27 and a predetermined reference value read from a reference value storage 25. The RAM 902b may be used for the reference value storage 25.

In the present embodiment, in addition to the reference value and the color-shift correction value described above, a detection-shift correction value for correcting the shift of the write start timing caused by the light amount fluctuation of the LD 28 is added. Here, the detection-shift characteristic value is a value indicating a characteristic of the detection shift generated when the light amount of the beam incident on a synchronization detection plate 41 (see FIG. 5) fluctuates.

Furthermore, the correction value calculator 26 is an example of a detection shift correction function unit that corrects a detection shift of the light detection sensor 200. Specifically, the correction value calculator 26 calculates a detection-shift correction value for correcting the detection shift of the light detection sensor 200 using the first light amount included in the execution result of the color-shift correction, the light amount (an example of the second light amount) determined as the lighting condition of the LD 28, and the detection-shift characteristic value. Here, the lighting condition is a lighting condition of the LD 28 when performing the printing operation. Next, the correction value calculator 26 adds the detection-shift correction value to the color-shift correction value. Furthermore, the correction value calculator 26 (an example of an update unit) updates the detection-shift characteristic value stored in the correction value storage 27.

Note that the color-shift correction value stored in the correction value storage 27 is updated at the time of color matching operation for correcting a shift between colors. By performing the color matching operation, an electrostatic latent image can be formed at a target position of each of the photoconductors 16, and a high-quality image can be formed. The correction value calculator 26 may update the color-shift correction value stored in the correction value storage 27 and the first light amount at substantially the same timing.

Furthermore, the correction value calculator 26 needs to enable a function of calculating the detection-shift correction value when receiving a print request among requests for operating the optical writing device of the color image forming apparatus, and needs to disable the function when receiving a request for color-shift correction.

The correction value calculator 26 includes a light amount setting step of setting the light amount of the LD 28, a pattern forming step of forming a shift amount calculation pattern (an example of a pattern) for detecting a detection shift generated when the light amount of the beam incident on the light detection sensor 200 fluctuates, and a pattern detecting step of detecting the formed shift amount calculation pattern. Then, the correction value calculator 26 repeats the light amount setting step, the pattern forming step, and the pattern detecting step. The correction value calculator 26 calculates a detection-shift characteristic value on the basis of a detection result of the shift amount calculation pattern and a detection result of the detection shift, and updates the detection-shift characteristic value stored in the correction value storage 27.

Furthermore, in the pattern forming step and the pattern detecting step, the shift amount calculation pattern may be formed and detected using the pattern forming unit and the pattern detecting unit used when the correction value calculator 26 corrects the color shift. Accordingly, the update of the detection-shift characteristic value can be realized without increasing the number of unnecessary components.

Furthermore, the shift amount calculation pattern may be common in all of the angle, length, width, and formation interval as compared with the color matching pattern formed by the correction value calculator 26. As a result, since the shift amount calculation pattern having the same shape as the color matching pattern in the case of correcting the color shift is used, the calculation accuracy of the detection-shift characteristic value can be improved.

Furthermore, the correction value calculator 26 may update the detection-shift characteristic value when it is determined that the update of the detection-shift characteristic value has been normally completed, and may notify that the update processing has been completed so that the update of the detection-shift characteristic value does not operate when the color image forming apparatus is powered on from the next time. As a result, the processing of updating the detection-shift characteristic value can be performed only once when the optical writing device is replaced.

Note that, for example, there is a difference in the detection-shift characteristic (the change amount of the write start timing when the light amount of the LD 28 changes) different for each optical writing device due to the influence of the beam spot diameter of the LD 28 as described above. Since it is hardly affected with time and corresponds to the characteristics of the optical writing device, the processing of updating the detection-shift characteristic value may be started only once immediately after the color image forming apparatus is assembled. Alternatively, the update processing may be started only once when the optical writing device of the color image forming apparatus is replaced. Therefore, it is detected whether or not the optical writing device has been replaced, and in a case where it is detected that the optical writing device is brand new, the update processing is automatically executed only once. In the present embodiment, the CPU 901 (an example of a replacement detector) detects whether or not the optical writing device has been replaced. Then, the CPU 901 may operate the update processing when it is detected that the optical writing device is new when the color image forming apparatus is powered on.

Furthermore, the detection-shift characteristic value may be stored in the correction value storage 27 as a detection-shift characteristic table in which detection shifts are arranged in a table. In this case, the correction value calculator 26 calculates two detection-shift characteristic values by referring to detection-shift characteristic values closest to the first light amount and the second light amount from the tabular array or performing interpolation processing, and calculates a detection-shift correction value based on a difference between the two detection-shift characteristic values. Then, the correction value calculator 26 performs interpolation processing of the detection-shift correction value on the basis of the detection result of the multiple detection shifts obtained by changing the light amount setting of the LD 28, and updates each detection-shift characteristic value of the tabular array stored in the correction value storage 27.

Furthermore, the correction value calculator 26 operates the LD 28 with three light amount settings to obtain a detection result of the three detection shifts. As a result, it is possible to realize a high-quality correction system while restricting an increase in the processing time for updating the detection-shift characteristic value.

Furthermore, the correction value calculator 26 may perform linear interpolation processing of the detection-shift correction values of the two neighboring points on the detection result of the detection shifts. As a result, it is possible to realize a high-quality correction system while restricting an increase in the processing time for updating the detection-shift characteristic value.

Furthermore, the detection-shift characteristic value may be stored in the correction value storage 27 as coefficients of an N-th order polynomial. In this case, the correction value calculator 26 calculates the detection-shift characteristic value corresponding to the first light amount and the second light amount using the coefficients of the N-th order polynomial, and calculates the detection-shift correction value from the difference between the two detection-shift characteristic values. Furthermore, the correction value calculator 26 calculates coefficients of the N-th order polynomial on the basis of the detection result of the detection shifts obtained by changing the light amount setting of the LD 28, and updates the coefficients of the respective N-th order polynomial stored in the correction value storage 27.

Furthermore, the correction value calculator 26 operates the LD 28 with the N+1 light amount settings to obtain a detection result of multiple detection shifts. As a result, it is possible to realize a high-quality correction system while restricting an increase in the processing time for updating the detection-shift characteristic value.

Furthermore, the detection-shift characteristic value may be stored in the correction value storage 27 as a coefficient of a third-order polynomial or a fourth-order polynomial. The correction value calculator 26 calculates the detection-shift characteristic value corresponding to the first light amount and the second light amount using the coefficient of the third polynomial or the fourth polynomial, and calculates the detection-shift correction value from the difference between the two detection-shift characteristic values. As a result, it is possible to realize a high-quality correction system while restricting an increase in the processing time for updating the detection-shift characteristic value.

The polygon motor 29 drives the polygon mirror 52 (see FIG. 5). A deflection controller 24 controls driving of the polygon motor 29. A sensor controller 21 controls detection of a beam by the light detection sensor 200.

FIG. 3 is a diagram for explaining an example of a correction function of the write start timing in the color image forming apparatus according to the present embodiment. The electrostatic latent image formed on the photoconductor 16 is developed with toner and transferred onto the intermediate transfer belt 18. Multiple TM/P sensors 12 that is provided to face the intermediate transfer belt 18 and detect toner on the intermediate transfer belt 18 are installed in a direction (main scanning direction) orthogonal to the belt conveyance direction.

At the time of executing color matching, a color matching pattern is formed so as to pass through a detection portion of each TM/P sensor 12, and is detected by the TM/P sensor 12. The correction value calculator 26 calculates a color-shift correction value for correcting a registration shift or a magnification shift between colors using the detection result.

FIG. 4 is a diagram illustrating an example of a synchronization detection plate in the color image forming apparatus according to the present embodiment. In FIG. 4, for simplification of description, the synchronization detection plate 41 is disposed immediately beside the photoconductor 16. In practice, the reflection mirror may be placed on the beam path of the LD 28, and the synchronization detection plate 41 may be disposed at a completely different position.

The light detection sensor 200 installed on the synchronization detection plate 41 is disposed on the scanning of the beam emitted from the LD 28. When the photoconductor 16 is scanned once, the light detection sensor 200 on the synchronization detection plate 41 detects the beam of the LD 28 immediately before or immediately after the scanning, and outputs a synchronization signal. The write start timing of the photoconductor 16 is determined on the basis of a synchronization signal input to the optical writing controller 20. That is, the light detection sensor 200 detects the write start timing of the electrostatic latent image by irradiation of the photoconductor 16 with the beam.

FIG. 5 is a diagram illustrating an example of a configuration of an optical writing device of the color image forming apparatus according to the present embodiment. Light (beam) emitted from the LDs 28 that scan the photoconductors 16 installed for each color is deflected on the surface of the polygon mirror 52 via a lens 51, transmits through an fθ lens 53 set to face, and irradiates the photoconductors 16 with the beam. When the polygon mirror 52 rotates, the beam scans the photoconductor 16 in one direction, and an electrostatic latent image corresponding to image data is formed on the photoconductor 16. That is, the polygon mirror 52 is a multi-sided reflector, and is an example of a deflector that is provided on an emission optical path of the beam from the LD 28, is rotationally driven by a signal input from the outside, deflects the light irradiated to the surface of the reflector, and scans the photoconductor 16 in one direction. Since the width of the electrostatic latent image becomes the image width, the outside of the width of the electrostatic latent image formed on the photoconductor 16 is treated as the outside of the image area. The reflection angle of the beam varies depending on the rotation angle of the polygon mirror 52, and the beam outside the image area is deflected by a mirror 54, and the synchronization detection plate 41 is irradiated with the beam via the fθ lens 53.

As described with reference to FIG. 4, since the light detection sensor 200 is disposed in the synchronization detection plate 41, the incident beam is detected and the synchronization signal is output to the optical writing controller 20. In the optical writing device mounted on the color image forming apparatus, the LDs 28 corresponding to the respective colors are provided, and beams are emitted toward different surfaces of the polygon mirror 52, and the photoconductors 16 of different colors are scanned via different fθ lenses 53. Another synchronization detection plate 41 is provided. Each of the two synchronization detection plates 41 is provided with the light detection sensor 200, and each light detection sensor 200 detects a beam incident from the LD 28 and outputs each synchronization signal to the optical writing controller 20.

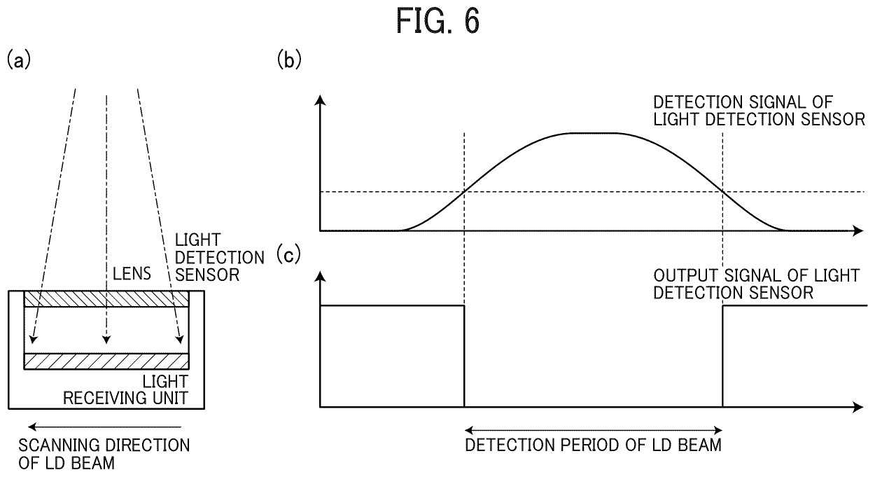

FIG. 6 is a diagram illustrating an example of a detection signal and an output signal of a beam of the light detection sensor of the color image forming apparatus according to the present embodiment. In the graph illustrated in FIG. 6, the vertical axis represents a signal output from the light detection sensor 200, and the horizontal axis represents time. The light detection sensor 200 includes a semiconductor element that generates a current when light is applied, such as a photodiode. In order to improve the detection accuracy of the light detection sensor 200, a slit or a lens for reducing ambient light and narrowing the incident direction of light may be provided. That is, the light detection sensor 200 may include a slit that limits the incident optical path of the beam from the LD 28. Although there is a possibility that the detection accuracy of the beam decreases due to the characteristics of the light detection sensor 200, it is possible to restrict the variation in the detection accuracy by providing the slit.

When the light receiving unit of the light detection sensor 200 is irradiated with a beam from the LD 28, a current is generated, and the current is amplified by the built-in operational amplifier circuit. Then, the amplified current flows to a gain resistor having an adjusted fixed value, and becomes a detection signal of the light detection sensor 200. This detection signal is an analog value and is a signal that is difficult to handle as it is. Therefore, the magnitudes of the detection signals of the light detection sensor 200 are compared by a comparator, and converted into a digital value output signal (synchronization signal) in which the beam is detected only in a period in which a certain voltage is exceeded. The output signal of the light detection sensor 200 converted into the digital value is passed to the optical writing controller 20, and it is determined whether the light detection sensor 200 has detected the beam from the LD 28.

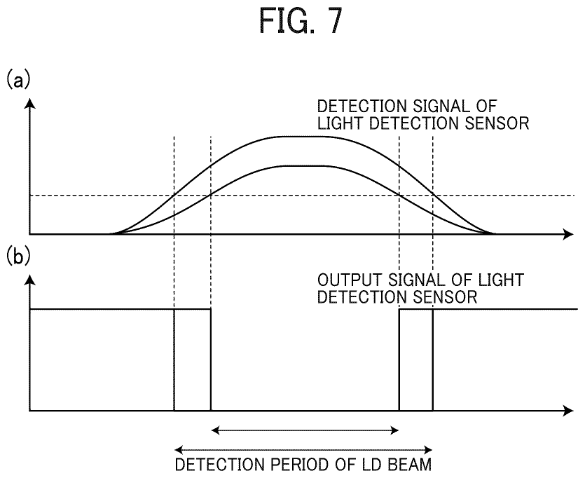

FIG. 7 is a diagram illustrating an example of a relationship between a light amount of a beam with which a light detection sensor of the color image forming apparatus according to the present embodiment is irradiated, and a detection signal and an output signal. In the graph illustrated in FIG. 7, the vertical axis represents a signal output from the light detection sensor 200, and the horizontal axis represents time. When the light amount from the LD 28 fluctuates, the detection signal of the light detection sensor 200 also fluctuates. When the light amount is large, the analog detection signal is also large, and when the light amount is small, the detection signal is small. As a result, the detection period of the beam of the LD 28 in the output signal of the light detection sensor 200 is widened or shortened. A falling edge or a rising edge of the detection signal is used as the detection position of the beam of the LD 28 incident on the synchronization detection plate 41. Therefore, when the light amount increases or decreases, the edge position fluctuates, and the write start timing deviates.

In order to restrict the shift of the write start timing, the following solution method is conventionally proposed. There is a method in which a reference voltage of a comparator of a light detection sensor can be adjusted and a detection period of a beam of an LD is made constant. There is also a method in which a detection period of a beam of an LD is measured, and a center position of the detection period of the beam of the LD is determined as a detection position, whereby the beam of the LD can be detected regardless of the magnitude of the light amount. However, in the above methods, in the case of preventing the shift of the write start timing between the multiple LDs 28 used for development with different developers, it is necessary to provide one synchronization detection plate 41 per color, and the number of components increases and the cost increases.

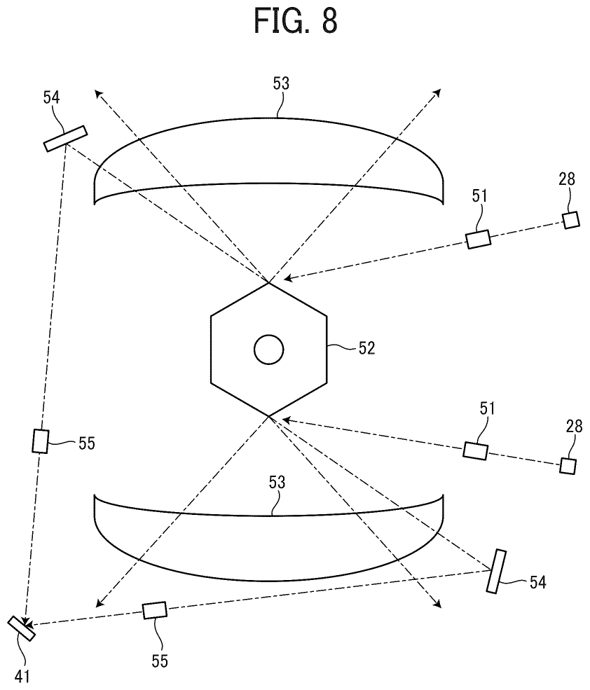

FIG. 8 is a diagram illustrating another example of the configuration of the optical writing device of the color image forming apparatus according to the present embodiment. In the optical writing device illustrated in FIG. 8, as compared with the optical writing device illustrated in FIG. 5, the synchronization detection plate 41 is integrated into one sheet, and beams emitted from the two LDs 28 are incident on one sheet of synchronization detection plate 41 at different angles. With this configuration, it is possible to delete one synchronization detection plate 41, which contributes to a reduction in manufacturing cost of the optical writing device. In the above methods, the detection accuracy of the beam of the LD is lowered, but according to the configuration illustrated in FIG. 8, the detection shift by the light detection sensor 200 is corrected, so that the detection accuracy of the beam emitted from each of the multiple LDs 28 by the light detection sensor 200 can be prevented from being lowered.

In a case of adopting a configuration in which the beams of all the LDs 28 are detected by one light detection sensor 200, the manufacturing cost of the optical writing device can be reduced, but a problem arises. In the method of adjusting the reference voltage of the comparator so that the detection period of the beam of the LD is constant, the light amount of one LD can be adjusted, but the light amount of the other LD cannot be simultaneously adjusted, and the write start timing of each color cannot be optimized. As a result, image quality deteriorates. Therefore, in a case where the beams emitted from the LDs 28 having different amounts of light are detected by the common light detection sensor 200, a method of making the detection period of the beams of the LDs 28 constant cannot be taken.

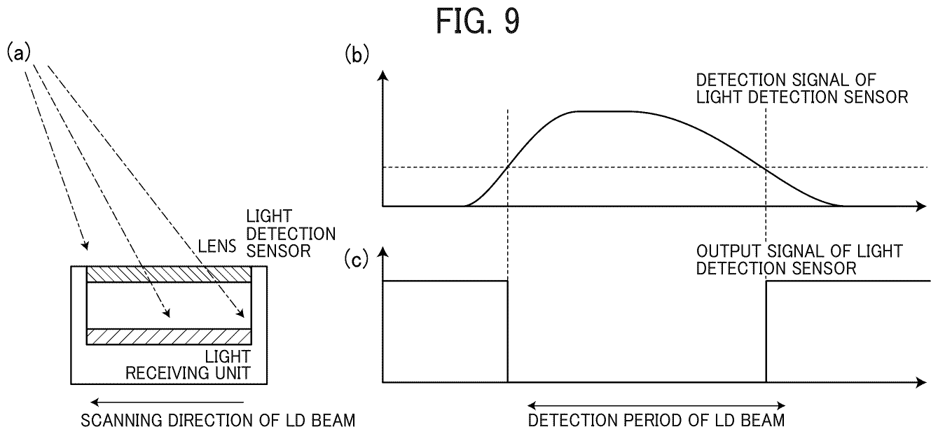

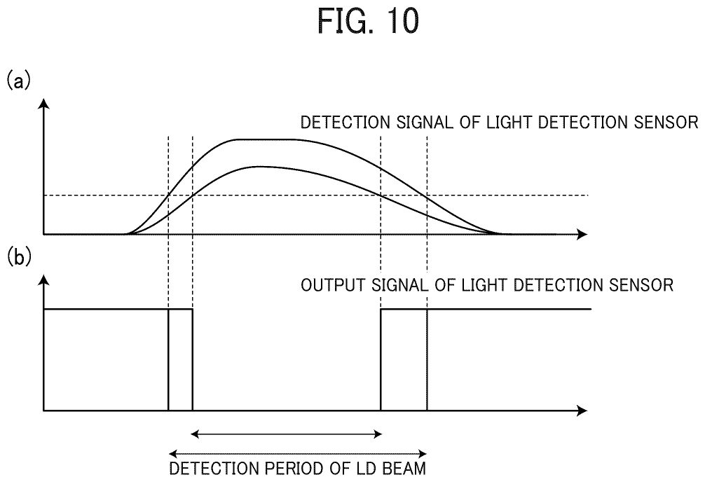

FIGS. 9 and 10 are diagrams illustrating examples of a detection signal and an output signal of a beam of the light detection sensor of the color image forming apparatus according to the present embodiment. In the graphs illustrated in FIGS. 9 and 10, the vertical axis represents a signal output from the light detection sensor 200, and the horizontal axis represents time. As compared with FIG. 6, the angle of the beam of the LD 28 incident on the light detection sensor 200 is inclined. As illustrated in FIG. 8, when multiple beams is incident on one light detection sensor 200, an incident angle may occur in each beam. At this time, the detection signal of the light detection sensor 200 may not be bilaterally symmetrical and may have a distorted waveform.

The example illustrated in FIG. 10 is a state of change when the angle of the beam of the LD 28 incident on the light detection sensor 200 is inclined as compared with FIG. 7. When the incident angle of the beam is inclined, the detection signal of the light detection sensor 200 is distorted without being bilaterally symmetrical. At this time, in a case where the light amount of the LD 28 is increased or decreased, the change amounts on the rising side of the detection waveform (left side in the drawing) and the falling side of the detection waveform (right side in the drawing) are not uniform. This indicates that the peak position of the beam is not at the center of the beam detection period of the LD 28. That is, in the method of measuring the detection period of the beam of the LD and setting the position delayed by ½ of the period from the falling edge as the detection position of the beam, an appropriate position cannot be determined as the peak position, and the write start timing cannot be optimized. As a result, image quality deteriorates.

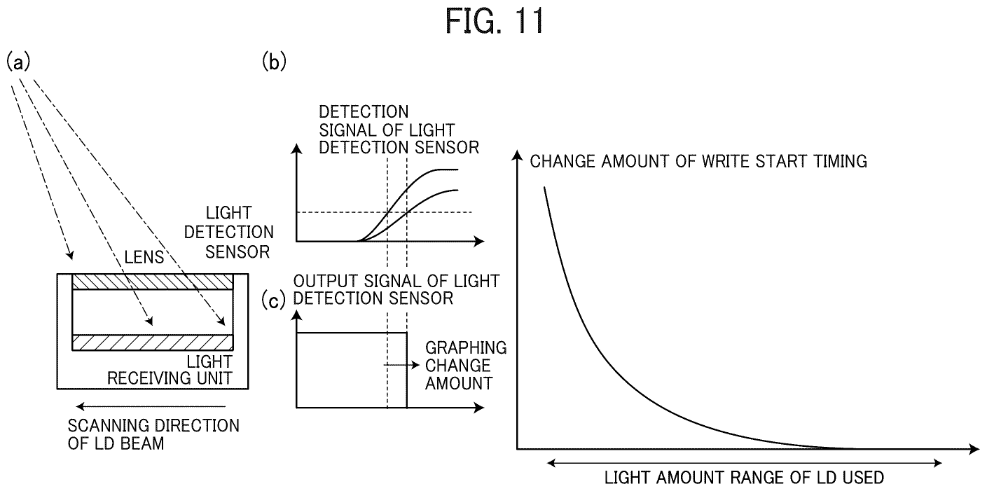

FIG. 11 is a diagram illustrating an example of a change in the write start timing of the color image forming apparatus according to the present embodiment. In the graph at the center of FIG. 11, the vertical axis represents a signal output from the light detection sensor 200, and the horizontal axis represents time. Furthermore, in the graph on the right side of FIG. 11, the vertical axis represents the change amount of the write start timing, and the horizontal axis represents the light amount of the LD 28. When the light amount of the LD 28 incident on the light detection sensor 200 increases or decreases, the falling edge of the output signal of the light detection sensor 200 deviates, and the write start timing of an image fluctuates. When the change amount is graphed, a non-linear shape is obtained. When the light amount is small, a voltage close to the reference voltage becomes a peak value, so that the sensitivity to the change in the light amount is high and the change amount is large. When the light amount is large, the reference voltage is easily exceeded, so that the sensitivity to the change in the light amount is low and the change amount is small.

The change amount of the write start timing described above is determined to be one by the physical configuration such as the incident angle of the beam of the LD 28 entering the light detection sensor 200, the slit, the lens, and the shape of the light receiving unit. In order to uniquely decide the change amount determined by the physical configuration, it is necessary to appropriately condense the beam of the LD 28 irradiating the light detection sensor 200 and narrow the beam spot diameter for irradiation. However, to narrow the beam spot diameter, a highly accurate condenser lens for the light detection sensor 200 is used, and the manufacturing cost increases. The above-described method can provide a high-quality image by optimizing the image write start timing while restricting an increase in the manufacturing cost of the optical writing device without using a high-accuracy condenser lens for narrowing the beam spot diameter and performing irradiation as described above.

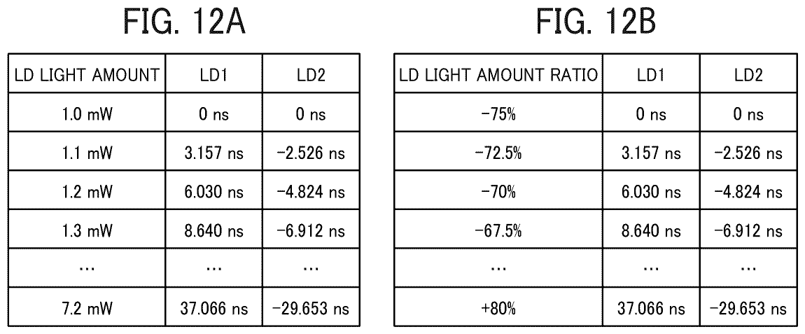

FIGS. 12A and 12B are diagrams illustrating an example of a detection-shift characteristic table in the color image forming apparatus according to the present embodiment. Specifically, FIGS. 12A and 12B are diagrams illustrating an example of a detection-shift characteristic table that associates the amount of light of the LDs 28 incident on the light detection sensor 200 mounted on the synchronization detection plate 41 with the change amount of the write start timing. The detection-shift characteristic table is provided for each LD 28 having a different beam path. When deciding one light amount incident on the light detection sensor 200, the correction value calculator 26 corrects the write start timing according to the detection-shift characteristic table.

For example, when the light amount of the LD 28 (LD1) is set to 1.3 mW and the light amount of the LD 28 (LD2) is set to 1.1 mW, the detection-shift characteristic table indicates that the write start timing of the LD1 needs to be delayed by 8.640 ns and the write start timing of the LD2 needs to be advanced by 2.526 ns. By using such a detection-shift characteristic table, even if the light amount of each LD 28 is fluctuated, it is possible to provide a high-quality image by restricting the shift of the write start timing. When the detection-shift characteristic table is referred to, the input value may be the light amount (mW) of the LD 28 or the light amount ratio (%) of the LD 28 to the reference light amount.

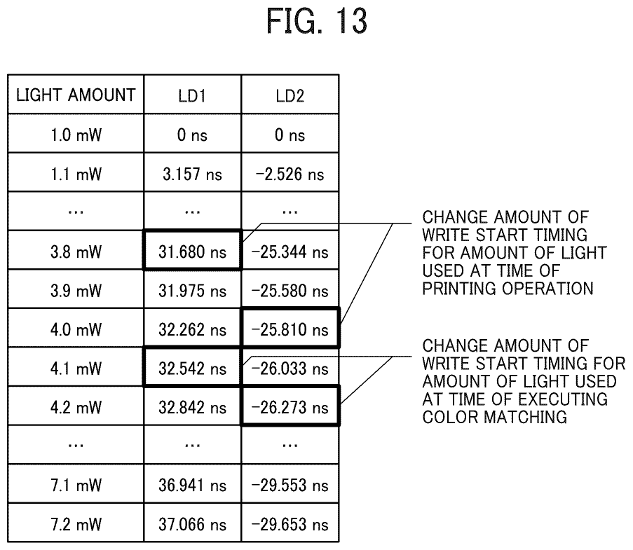

FIG. 13 is a diagram for describing an example of a method of using a detection-shift characteristic table in the color image forming apparatus according to the present embodiment. As described with reference to FIGS. 12A and 12B, the detection-shift characteristic table is a table of detection-shift characteristic values when the light amount of the LD 28 fluctuates. Here, how to use the detection-shift characteristic table in an image processing apparatus such as a color image forming apparatus will be described.

The shift between colors in the color image forming apparatus is corrected at the time of color matching. Since it is necessary to form a color matching pattern on the intermediate transfer belt 18, the color matching pattern is formed with some light amount for each LD 28. The write start timing is determined based on the output signal of the light detection sensor 200, and there is no difference between the time of forming the color matching pattern and the time of the printing operation, and if the light amount of the LD 28 fluctuates, a shift occurs in the same manner. When the color matching pattern is formed, the timing of the write start timing is shifted according to the light amount, but the color-shift correction value calculated for performing color matching in that state also includes the detection-shift correction value.

In FIG. 13 as an example, if the light amount of the LD 28 (LD1) at the time of performing color matching is 4.1 mW, the write start timing is shifted by 32.542 ns, but a correction value including the shift of 32.542 ns is calculated in the color-shift correction value calculated by color matching. Therefore, when the light amount of the LD1 at the time of the printing operation is 4.1 mW, adjustment is made so that an image can be formed at a position optimized by color matching.

A method of using the detection-shift characteristic table in the present embodiment is defined as follows. The correction value calculator 26 stores the light amount of each of the LDs 28 as the operating condition at the time of performing color matching, and corrects the write start timing so as to cancel the difference between the detection-shift characteristic value caused by the light amount at the time of performing printing and the detection-shift characteristic value caused by the light amount at the time of performing color matching. Taking FIG. 13 as an example, when the light amount of the LD1 at the time of performing color matching is 4.1 mW and the light amount at the time of performing the printing operation is 3.8 mW, as indicated in the following Expression (1), the write start timing of the LD1 can be corrected by correcting −0.862 ns, which is the difference between the two detection-shift characteristic values in the detection-shift characteristic table. Furthermore, when the light amount of the LD2 at the time of performing color matching is 4.2 mW and the light amount at the time of performing printing operation is 4.0 mW, the write start timing of the LD2 can be corrected by correcting 0.463 ns, which is the difference between the two detection-shift characteristic values in the detection-shift characteristic table, as indicated in the following Expression (2).

LD1: Detection-shift characteristic value at the time of printing operation-Detection-shift characteristic value at the time of color matching=31.680 ns−32.542 ns=−0.862 ns Expression (1)

LD2: Detection-shift characteristic value at the time of printing operation-Detection-shift characteristic value at the time of color matching=−25.810 ns−(−26.273 ns)=0.463 ns Expression (2)

In this way, by calculating the detection-shift correction value of each of the LD1 and the LD2, it is possible to restrict the shift of the write start timing occurring at the time of image formation and to provide a high-quality image.

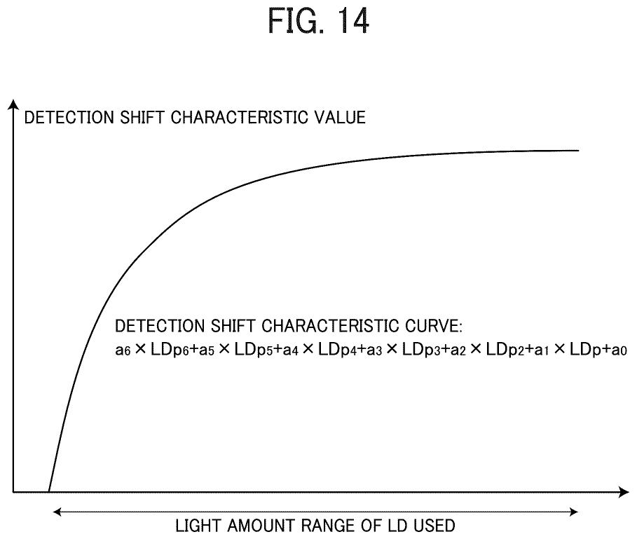

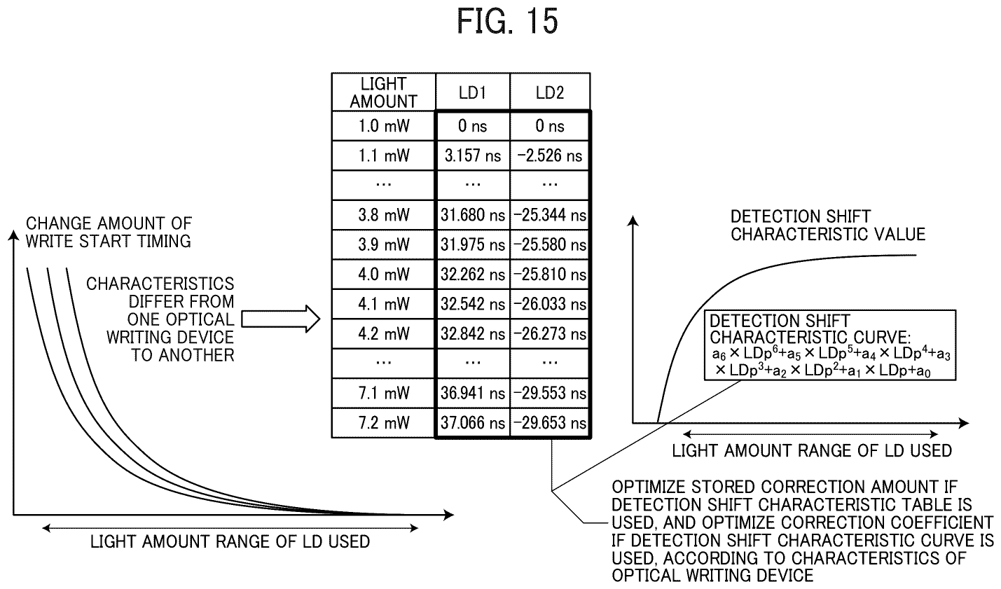

FIG. 14 is a diagram for explaining an example of a method of correcting the write start timing in a case where the detection-shift characteristic curve of the N-th polynomial is used instead of the detection-shift characteristic table in the color image forming apparatus according to the present embodiment. In FIG. 14, the vertical axis represents the detection-shift characteristic value, and the horizontal axis represents the light amount of the LD 28. As illustrated in FIGS. 12 and 13, the present embodiment proposes a method of adjusting the write start timing using the detection-shift characteristic table. However, in order to perform the correction with high accuracy using the detection-shift characteristic table, there is a problem that data needs to be finely held and a storage area is greatly consumed. Therefore, in the present embodiment, as another form, a method of correcting the write start timing using a detection-shift characteristic curve of a polynomial is also proposed.

Specifically, the correction value calculator 26 calculates an approximate curve of a polynomial from each plot point of the change amount of the write start timing in FIG. 11 as a detection-shift characteristic curve, and decides coefficients a₀ to aₙ (up to a₆ in the drawing) in advance. Furthermore, the correction value calculator 26 calculates the detection-shift characteristic value by using the light amount LDp of the LD 28 as an input value, multiplying the input value by the coefficients a₀ to aₙ, and summing each term from the 0 power to the n power of LDp.

A method of using the detection-shift characteristic curve of the polynomial in the present embodiment is determined as follows. The correction value storage 27 stores the light amount of each LD 28 as an operation condition at the time of executing color matching. The correction value calculator 26 obtains a difference (detection-shift correction value) between the detection-shift characteristic value generated with the light amount at the time of printing execution and the detection-shift characteristic value generated with the light amount at the time of color matching execution, and corrects the write start timing so as to cancel the difference.

For example, it is assumed that coefficients are a₀=−42.249, a₁=62.972, a₂=−24.779, a₃=5.0273, a₄=−0.4872, a₅=0.0151, and a₆=0.0003. When the light amount of the LD 28 (LD1) at the time of executing the color matching is 4.1 mW and the light amount at the time of the printing operation is 3.8 mW, the correction value calculator 26 calculates the detection-shift characteristic values in the detection-shift characteristic curve as 27.1360 ns and 26.3738 ns, respectively, as indicated in the following Expressions (3) and (4).

Detection-shift characteristic value at the time of color matching=0.0003×4.1⁶+0.0151×4.1⁵−0.4872×4.1⁴+5.0273×4.1³−24.779×4.1²+62.972×4.1−42.249=27.1360 ns Expression (3)

Detection-shift characteristic value at the time of printing operation=0.0003×3.8⁶+0.0151×3.8⁵−0.4872×3.8⁴+5.0273×3.8³−24.779×3.8²+62.972×3.8−42.249=26.3738 ns Expression (4)

Then, the correction value calculating unit 26 calculates −0.7622 ns, which is a difference between the two detection-shift characteristic values, as a detection-shift correction value as expressed in the following Expression (5), and corrects the color shift on the basis of the detection-shift correction value, thereby correcting the write start timing of the LD1.

LD1: Detection-shift characteristic value at the time of printing operation-Detection-shift characteristic value at the time of color matching=26.3738 ns−27.1360 ns=−0.7622 ns Expression (5)

The detection-shift characteristic curve of the polynomial is also held for each color similarly to the detection-shift characteristic table.

FIG. 15 is a diagram for explaining an example of updating of the detection-shift characteristic table or the detection-shift characteristic curve in accordance with the characteristics of the optical writing device in the color image forming apparatus according to the present embodiment. As illustrated in FIGS. 12, 13, and 14, in the present embodiment, the write start timing is adjusted using the detection-shift characteristic table or the detection-shift characteristic curve. However, even in a configuration using the detection-shift characteristic table or the detection-shift characteristic curve, the write start timing may not be corrected with high accuracy.

As described above, in a case where the beam spot diameter of the LD 28 that irradiates the light detection sensor 200 of the synchronization detection plate 41 is not narrowed, the beam spot diameter greatly changes for each optical writing device. As a result, the amount of change in the write start timing when the light amount of the LDs 28 changes greatly fluctuates for each optical writing device. Then, the detection-shift characteristic table that has been appropriately corrected by a certain optical writing device cannot be appropriately corrected by another optical writing device.

Therefore, in the present embodiment, as described above, the correction value calculator 26 updates the detection-shift characteristic table or the detection-shift characteristic curve.

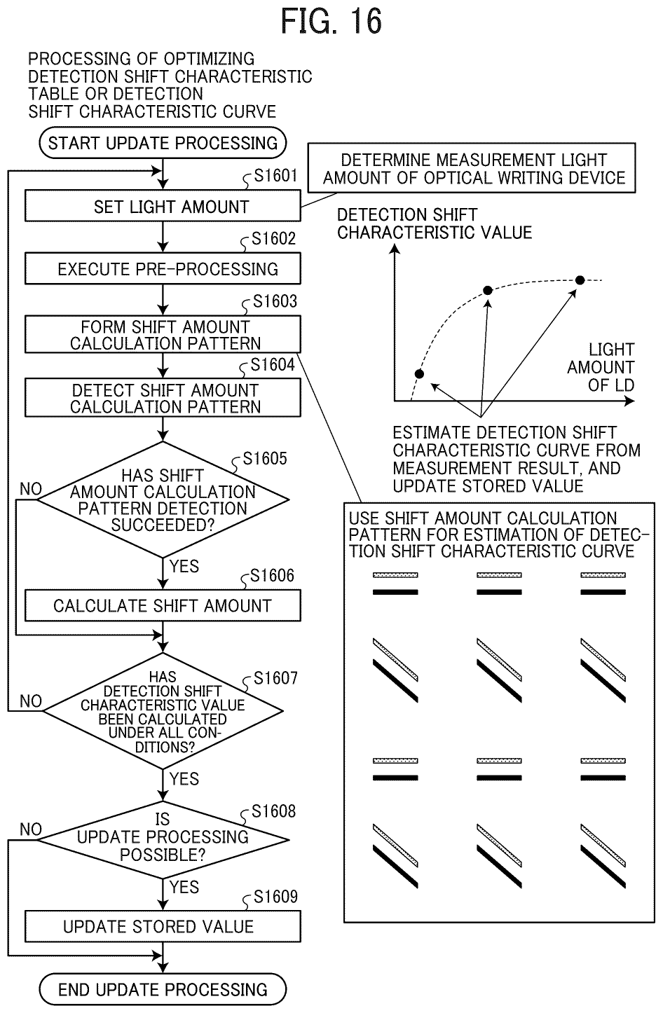

FIG. 16 is a diagram for explaining an example of processing of updating the detection-shift characteristic table or the detection-shift characteristic curve in the color image forming apparatus according to the present embodiment. Since the value of the detection-shift characteristic table is stored in the correction value memory in a case where the detection-shift characteristic table is used and the coefficient of the detection-shift characteristic curve is stored in the correction value storage 27 in a case where the detection-shift characteristic curve is used, a method for updating the stored value will be described.

The correction value calculator 26 executes a light amount setting step of setting the light amount of the LD 28 (step S1601). Next, the correction value calculator 26 executes a detection pre-processing step of performing pre-processing of pattern detection (step S1602). Specifically, in the detection pre-processing step, preparation is performed before forming and detecting the shift amount calculation pattern. In the pre-preparation, the optical writing controller 20 adjusts the light emission intensity of the TM/P sensor 12 while rotating the intermediate transfer belt 18 and the like.

Next, the correction value calculator 26 performs a shift amount calculation pattern formation step of forming a shift amount calculation pattern for calculating the shift amount (step S1603). Furthermore, the correction value calculator 26 performs a shift amount calculation pattern detection step of detecting a shift amount calculation pattern (step S1604). Furthermore, the correction value calculator 26 determines whether or not the detection of the shift amount calculation pattern has succeeded (step S1605).

In a case where the shift amount calculation pattern is not detected (step S1605: No), the correction value calculator 26 proceeds to step S1607 without calculating the detection-shift characteristic value. On the other hand, in a case where the shift amount calculation pattern is detected (step S1605: Yes), the correction value calculator 26 performs a shift amount calculation step of calculating a detection-shift characteristic value (step S1606). Next, the correction value calculator 26 determines whether or not the detection-shift characteristic value has been calculated under all conditions (step S1607). In a case where the detection-shift characteristic value is not calculated under all the conditions (step S1607: No), the processing returns to step S1601.

In a case where the detection-shift characteristic value is calculated under all the conditions (step S1607: Yes), the correction value calculator 26 determines whether or not the update processing of the detection-shift characteristic table or the detection-shift characteristic curve is possible based on the calculation result of the detection-shift characteristic value (step S1608). In a case where the processing of updating the detection-shift characteristic table or the detection-shift characteristic curve cannot be performed (step S1608: No), the update processing is ended. On the other hand, in a case where the processing of updating the detection-shift characteristic table or the detection-shift characteristic curve is possible (step S1608: Yes), the correction value calculator 26 executes the processing of updating the detection-shift characteristic table or the detection-shift characteristic curve (step S1609).

By processing a series of steps from step S1601 to step S1606, the calculation result of the detection-shift characteristic value in the light amount of one LD 28 is output. Multiple calculation results of the detection-shift characteristic values are output by repeatedly performing a series of steps from step S1601 to step S1606 while changing the light amount of the LD 28. On the basis of these calculation results, each stored value of the detection-shift characteristic table is updated in the case of the detection-shift characteristic table, and the coefficient of each polynomial is updated in the case of the detection-shift characteristic curve.

Here, the shift amount calculation pattern is a pattern that can detect the shift in the main scanning direction. Basically, the shift amount calculation pattern is configured by a pattern in which patterns of different angles are combined, such as a cross line pattern and an oblique line pattern. In the present embodiment, a pattern having the same shape as the color matching pattern used in the color matching processing of the color image forming apparatus is used. As a result, it is possible to restrict the influence of the difference in pattern shape on the calculation result of the shift amount and ideally estimate the characteristics of the detection shifts of the optical writing device (the amount of change in the write start timing when the light amount of the LD changes).

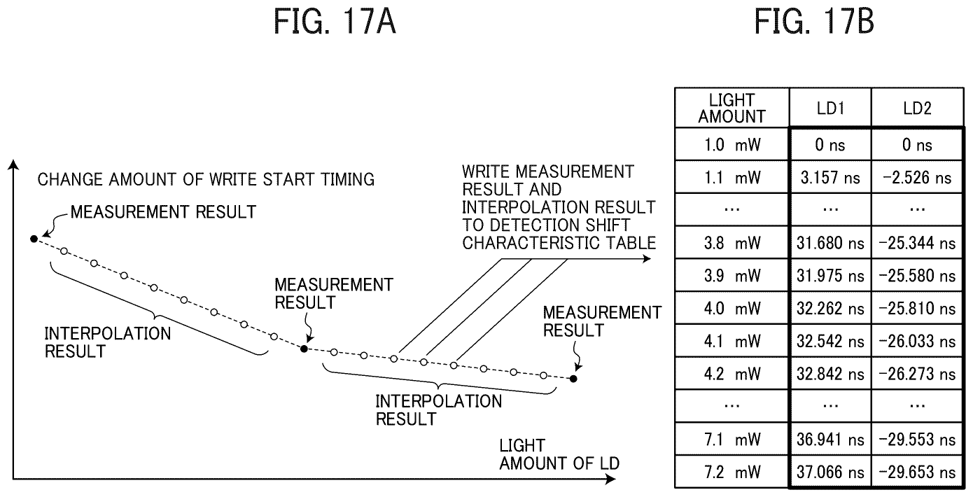

FIGS. 17A and 17B are diagrams for explaining an example of details of a method of updating the detection-shift characteristic table in the color image forming apparatus according to the present embodiment. By repeatedly performing a series of steps from step S1601 to step S1605 illustrated in FIG. 16, the characteristics of the detection shifts of the optical writing device can be estimated. However, when the detection-shift characteristic value is calculated with the light amounts of all the LDs 28 in the detection-shift characteristic table, the number of calculations of the detection-shift characteristic value becomes enormous, and it takes time for the update processing.

Therefore, in the present embodiment, a series of steps from step S1601 to step S1605 of the update processing of the detection-shift characteristic value is repeatedly performed with the number of light amount settings smaller than the number of arrays of the detection-shift characteristic table. Then, after the characteristics of the detection shifts of the optical writing device are estimated from the calculation result of the detection-shift characteristic value, interpolation processing is performed in accordance with the number of arrays of the detection-shift characteristic table. By performing the processing in this manner, it is possible to accurately update the value stored in the detection-shift characteristic table in a short time.

Furthermore, when the value stored in the detection-shift characteristic table is updated, the calculation result of one detection-shift characteristic value is used as the reference value, and the difference from the reference value is stored. By performing the calculation in this manner, the value stored in the detection-shift characteristic table can be restricted to a certain level, and it is possible to prevent overflow of the stored value and reduce memory consumption.

Furthermore, in the present embodiment, the number of calculation points of the detection-shift characteristic value is three. As described with reference to FIG. 11, the characteristics of the detection shifts of the optical writing device have a nonlinear shape. When the number of calculation points of the detection-shift characteristic values is reduced as much as possible and interpolation is performed with high accuracy, at least three calculation results of the detection-shift characteristic values are used. This is because the calculation results of the detection-shift characteristic values at the two points do not become nonlinear. Furthermore, in the present embodiment, the correction value calculator 26 performs linear interpolation processing. Even with simple interpolation processing, the shift can be accurately corrected, and a high-quality image can be provided.

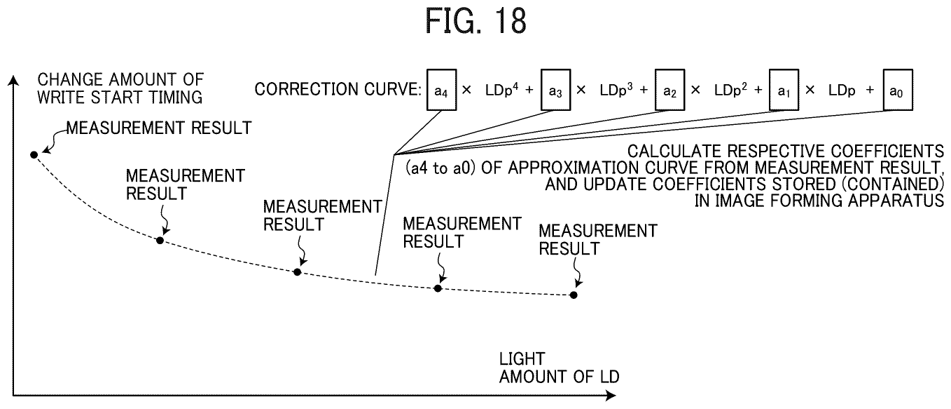

FIG. 18 is a diagram for explaining an example of details of a method of updating a detection-shift characteristic curve in the color image forming apparatus according to the present embodiment. As described with reference to FIG. 14, since the detection-shift characteristic curve is used instead of the detection-shift characteristic table in another form of the present embodiment, the update processing when the detection-shift characteristic curve is used will be described here.

In another form of the present embodiment, a series of steps from step S1601 to step S1606 of the update processing is repeatedly performed with the number of calculation points of N+1 larger than the order N of the approximate expression of the detection-shift characteristic curve. Then, a₀ is calculated from the coefficients aₙ of the orders of the approximate expressions passing through all the N+1 calculation results. As a result, the detection-shift characteristic value of the optical writing device can be accurately approximated in a short time.

Furthermore, the order N of the approximate expression approximating the detection-shift characteristic value of the optical writing device is set to 3 or 4. When the order of the approximate expression is 5 or more, there is a risk that the distortion of the detection-shift characteristic curve increases locally between the calculation points. By performing the calculation in this manner, it is possible to perform accurate approximation while reducing the number of calculation points.

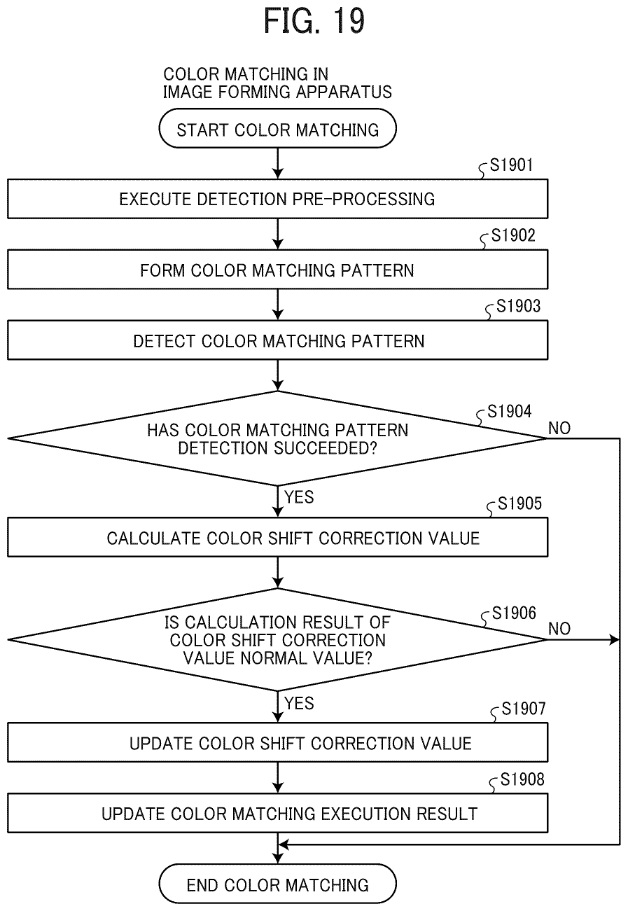

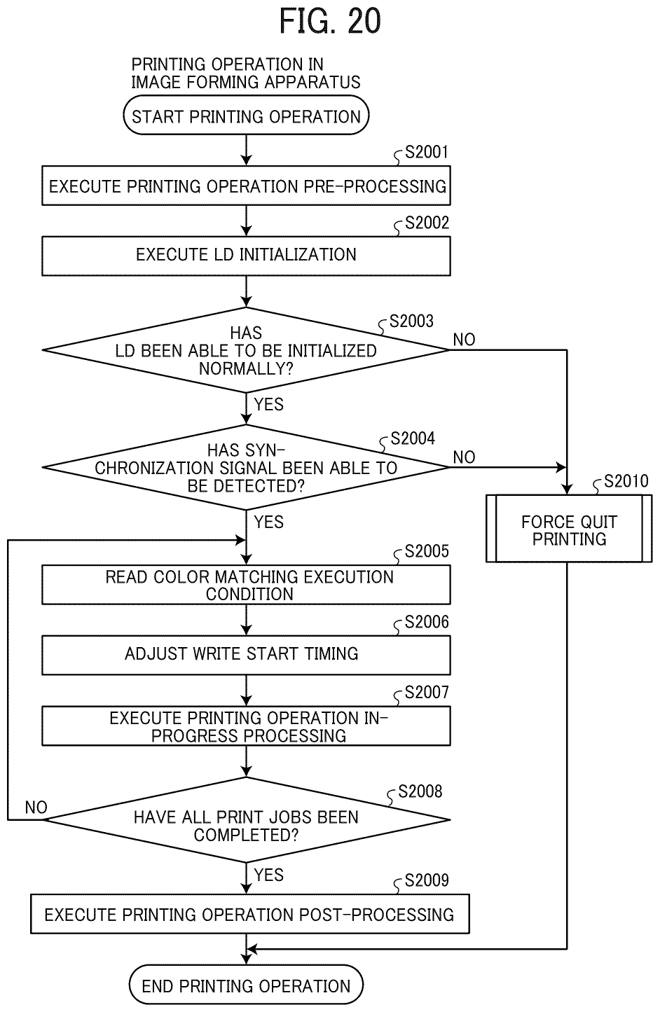

FIG. 19 is a flowchart illustrating an example of a flow of color matching processing in the color image forming apparatus according to the present embodiment. FIG. 20 is a flowchart illustrating an example of a flow of a printing operation in a color image forming apparatus according to the present embodiment. The method of correcting the write start timing is processed in the two flowcharts.

First, an example of a flow of color matching processing in a color image forming apparatus will be described. The optical writing controller 20 executes detection pre-processing (step S1901). Specifically, the optical writing controller 20 performs preparation before forming and detecting the color matching pattern. Furthermore, the optical writing controller 20 adjusts the light emission intensity of the TM/P sensor 12 while rotating the intermediate transfer belt 18 and the like.

Next, the optical writing controller 20 forms a color matching pattern (step S1902). Specifically, the optical writing controller 20 performs setting related to formation of a color matching pattern.

Next, the optical writing controller 20 detects a color matching pattern (step S1903). Further, the optical writing controller 20 determines whether or not the detection of the color matching pattern has succeeded (step S1904). Specifically, the optical writing controller 20 performs the processing related to the detection of the color matching pattern, and ends the detection processing of the color matching pattern at the time point when all the formed color matching patterns have been detected (step S1904: Yes), and proceeds to step S1905. On the other hand, in a case where the color matching pattern is not detected (Step S1904: No), the optical writing controller 20 ends the color matching processing.

Next, the correction value calculator 26 performs processing of calculating a color-shift correction value (step S1905). Specifically, the correction value calculator 26 calculates a color-shift correction value for correcting a shift between colors using the detection result of the color matching pattern. Here, the shift between colors includes a shift such as a main scanning resist shift, a sub-scanning resist shift, a skew shift, a magnification shift, and a partial magnification shift. The shift of the write start timing is included in the main scanning resist shift, and a color-shift correction value for correcting the main scanning resist shift between colors at the time of color matching is calculated.

Next, in a case where the calculated color-shift correction value is a normal value (step S1906: Yes), the correction value calculator 26 updates the color-shift correction value and the first light amount (step S1907). Specifically, the correction value calculator 26 updates the color-shift correction value and the first light amount stored in the correction value storage 27. However, when the color matching is not normally performed, such as the color matching pattern detection and the calculation result of the correction value, the processing of updating the color-shift correction value and the first light amount is skipped. That is, the first light amount stored in the correction value storage 27 is not updated in a case where color matching is not normally performed.

Next, the correction value calculator 26 updates the execution result of the color matching processing (step S1908). Specifically, the correction value calculator 26 updates the execution result of color matching stored in the correction value storage 27. Here, the execution result of the color matching processing includes the internal temperature at the time of execution and the light amount of the LD 28. However, when the color matching is not normally performed such as the detection of the color matching pattern and the calculation result of the correction value, the update processing of the execution result of the color matching processing is skipped.

Next, an example of a flow of a printing operation of the color image forming apparatus according to the present embodiment will be described. First, the optical writing controller 20 executes a printing operation pre-processing (step S2001). Specifically, the optical writing controller 20 performs activation processing of the optical writing device after a print job is entered. Here, the activation processing of the optical writing device includes activation of the LD driver, rotation of the polygon motor 29, decision of the light amount of the LD 28 during the printing operation, and the like.

Next, the optical writing controller 20 executes initialization processing of the LDs 28 (step S2002). Specifically, the optical writing controller 20 initializes the light amount of the LD 28 to be the target light amount. Furthermore, the optical writing controller 20 starts synchronous lighting so that the light detection sensor 200 of the synchronization detection plate 41 can detect the beam of the LD 28.

Next, in a case where initialization of the LD 28 is normally performed (step S2003: Yes) and a synchronization signal is detected (step S2004: Yes), the correction value calculator 26 reads an execution result of color matching (step S2005). Specifically, the correction value calculator 26 reads the light amount of the LD 28 at the time of executing the color matching stored at the time of executing the color matching processing. In a case where the initialization of the LD 28 is not normally performed (step S2003: No) or in a case where the synchronization signal is not detected (step S2004: No), the optical writing controller 20 force quits the printing processing (step S2010).

Next, the correction value calculator 26 adjusts the write start timing (step S2006). Specifically, the correction value calculator 26 refers to the detection-shift characteristic table and adjusts the write start timing for each color using the light amount of the LD 28 at the time of the printing operation and the light amount of the LD 28 at the time of performing color matching.

Next, the optical writing controller 20 executes a printing operation in-progress processing (step S2007). Specifically, the optical writing controller 20 turns on and off the LDs 28 according to the image data, and performs processing for forming a desired electrostatic latent image on the photoconductor 16.

Thereafter, in a case where all the print jobs have been completed (step S2008: Yes), the optical writing controller 20 executes printing operation post-processing (step S2009). Specifically, the optical writing controller 20 performs neutralization of the photoconductor 16 after completion of printing, stop of the LD driver, stop of the polygon motor 29, and the like.

In the color matching processing, a color matching pattern is formed, and the color matching pattern is detected to calculate the color shift amount and correct the write start timing to reduce the color shift. As described above, in the present embodiment, when the color matching pattern is formed, the function (correction function) of calculating the detection-shift correction value of the optical writing device described in FIGS. 12 to 18 is disabled. Then, the light amount of the LD 28 when the color matching pattern is formed is stored.

The writing start timing is shifted by the difference between the light amount of the LD28 during the printing operation and the light amount of the LD28 stored in the storage unit due to the detection-shift characteristic of the optical writing device.

The color image forming apparatus adds the detection-shift correction value calculated by the detection-shift characteristic table or the detection-shift characteristic curve to the color-shift correction value calculated by the color matching processing to correct the shift of the writing start timing.

The light amount of the LDs 28 is stored in the color matching execution result update step (step S1908), and the write start timing of the print operation is corrected in the write start timing adjustment step (step S2006). Note that although the timing at which the correction function is disabled has been described above, there is also a timing at which the correction function is enabled. It is necessary to enable the correction function when forming an image or pattern of such high quality that the influence of the detection-shift characteristic value of the optical writing device is noticeable. In the color image forming apparatus, the correction function of the optical writing device is enabled at the time of printing operation.

As described above, according to the color image forming apparatus according to the present embodiment, even if an inexpensive LD driver without a shading correction function is used, it is possible to provide a technique for restricting a shift in image data write start timing, and thus it is possible to output a high-quality image at low cost.

A color image forming apparatus includes a photoconductor on which an image is formed, an optical writing device to exposes the photoconductor with light, the optical writing device including: a light emitter to emit light, a deflector including a multifaceted reflector rotationally driven to deflect the light emitted from the light emitter to scan the photoconductor with the light in a scanning direction, a synchronization detector to detect a write start timing of the light to be irradiated onto the photoconductor from the deflector, circuitry configured to: control the light emitter to emit light, correct a detection shift of the synchronization detector generated by a fluctuation of a light amount of the light incident on the synchronization detector, and adjust the write start timing to correct a color shift, a memory to store: an execution result including a first light amount of the light emitter to correct the color shift, a color-shift correction value to correct the color shift of each colors in the scanning direction, and a detection-shift characteristic value indicating a characteristic of the detection shift. The circuitry is further configured to: calculates a detection-shift correction value to correct the detection shift based on: the first light amount, a second light amount for emitting the light emitter as a lighting condition, and the detection-shift characteristic value, add the detection-shift correction value to a color-shift correction value to adjust the write start timing, and update the detection-shift characteristic value stored in the memory.

The circuitry is further configured to control the light emitter to emit a constant light amount while the light emitter irradiating the light from one end to another end of a surface of the deflector scanning in the scanning direction.

The color image forming apparatus further includes multiple light emitters including the light emitter; and multiple photoconductors including the photoconductor, and the multiple light emitters respectively irradiate the multiple photoconductors, and the optical writing device irradiates the synchronization detector with light emitted from the multiple light emitters.

The synchronization detector includes a slit to limit a light path of the light incident from the light emitter.

The circuitry is further configured to, among requests to operate the optical writing device: enable calculating the detection-shift correction value to correct the detection shift in response to a receipt of a print request, and disable the calculating the detection-shift correction value in response to a receipt of a request of the color-shift correction.

The circuitry updates the color-shift correction value and the first light amount stored in the memory at a same timing.

The circuitry is further configured to, while changing the light amount, repeatedly perform: setting a light amount of the light emitter, forming a pattern to detect the detection shift, and detecting the pattern to: calculate the detection-shift characteristic value based on the pattern detected, and update the detection-shift characteristic value stored in the memory.

The color image forming apparatus further includes a sensor to detect a pattern to correct the color shift, and the circuitry is further configured to detect the pattern to detect the detection shift by the sensor.

The circuitry forms patterns for calculating the detection-shift characteristic value, the patterns are common in an angle, a length, a width, and a formation interval, as compared with the pattern formed in the color-shift correction.

The color image forming apparatus further includes: a replacement detector to detect a replacement of the optical writing device, and the circuitry is further configured to: update the detection-shift characteristic value stored in the memory, when a power supply of the color image forming apparatus is turned on, and when the replacement detector detects the replacement of the optical writing device.

The color image forming apparatus further includes a display, and the circuitry is further configured to: update the detection-shift characteristic value, and display a completion of updating the detection-shift characteristic value on the display.

The circuitry is further configured to store the detection-shift characteristic value in a tabular array in the memory, calculate two detection-shift characteristic values by: referring to the detection-shift characteristic value closest to the first light amount and the second light amount from the tabular array; or performing interpolation processing; and calculate the detection-shift correction value based on a difference between the two detection-shift characteristic values.

The circuitry is further configured to control the light emitter to emit the light at three light amount to obtain a detection result of multiple detection shifts including the detection shift while changing the light amount; and perform interpolation processing on the detection-shift correction value based on the multiple detection shifts; and update the detection-shift characteristic value in each of the tabular array stored in the memory.

The circuitry is further configured to perform a linear interpolation process to correct the detection-shift correction values of two neighboring points on a detection result of the detection shift.

The circuitry is further configured to store the detection-shift characteristic value in the memory as coefficients of an N-th order polynomial; calculate the detection-shift characteristic value corresponding to each of the first light amount and the second light amount using the coefficients of the N-th order polynomial; and calculate the detection-shift correction value from a difference between the detection-shift characteristic value corresponding to the first light amount and the detection-shift characteristic value corresponding to the second light amount.

The circuitry is further configured to control the light emitter to emit the light at N+1 light amount to obtain multiple detection shifts including the detection shift while changing the light amount at N+1 numbers of settings; calculate the coefficients of the N-th order polynomial based on the multiple detection shifts; and update the coefficients of each of the N-th order polynomial stored in the memory.

The circuitry is further configured to store the detection-shift characteristic value in the memory as coefficients of a third-order polynomial or a fourth-order polynomial, and calculate the detection-shift characteristic value corresponding to each of the first light amount and the second light amount using the coefficients of the third-order polynomial or the fourth-order polynomial, and calculate the detection-shift correction value from a difference between the detection-shift characteristic value corresponding to the first light amount and the detection-shift characteristic values corresponding to the second light amount.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Note that, in the above embodiment, an example in which the image forming apparatus of the present embodiment is applied to a multifunction peripheral having at least two functions of a copy function, a printer function, a scanner function, and a facsimile function is described, but the present embodiment can be applied to any image forming apparatus of a copier, a printer, a scanner device, and a facsimile device.

According to the present embodiment, it is possible to output a high-quality image at low cost.

Aspects of the present embodiment are, for example, as follows.

### Aspect 1

According to Aspect 1, an electrophotographic color image forming apparatus that forms an image by developing a developer on an electrostatic latent image formed on a photoconductor, includes an optical writing device that exposes the photoconductor, the optical writing device including: a light emitter that irradiates the photoconductor with light;
a light emitting control element that controls light emission of the light emitter; a deflector that is a multifaceted reflector, is provided on an emission optical path of light from the light emitter, is rotationally driven by a signal input from an outside, and deflects light irradiated onto a surface of the reflector to scan the photoconductor in one direction; a synchronization detector that detects a write start timing of an electrostatic latent image by irradiation of light onto the photoconductor; a color-shift correction function unit that adjusts the write start timing from when the synchronization detector detects light to when light emission control by the light emitting control element according to image data is started, to correct a color shift; a memory that stores an execution result of color-shift correction, a color-shift correction value, and a detection-shift characteristic value indicating a characteristic of a detection shift generated when a light amount of light incident on the synchronization detector fluctuates; a detection shift correction function unit that corrects a detection shift of the synchronization detector; and an update unit that updates the detection-shift characteristic value stored in the memory, and the execution result includes a first light amount of the light emitter when the color shift is corrected, and the detection shift correction function unit calculates a detection-shift correction value for correcting a detection shift of the synchronization detector using the first light amount, a second light amount determined as a lighting condition of the light emitter, and the detection-shift characteristic value, and adds the detection-shift correction value to the color-shift correction value.

### Aspect 2

According to Aspect 2, in the color image forming apparatus of Aspect 1, the light emitting control element controls a light amount of the light emitter to be constant while light irradiated from one end to another end of one surface of the deflector scans in one direction.

### Aspect 3

According to Aspect 3, in the color image forming apparatus of Aspect 1 or Aspect 2, the optical writing device irradiates one of the synchronization detectors with light from multiple the light emitters.

### Aspect 4

According to Aspect 4, in the color image forming apparatus of any one of Aspect 1 to Aspect 3, the synchronization detector includes a slit that limits an incident optical path of light from the light emitter.

### Aspect 5

According to Aspect 5, in the color image forming apparatus of any one of Aspect 1 to Aspect 4, among requests for operation of the optical writing device of the color image forming apparatus, the detection shift correction function unit enables a function of calculating the detection-shift correction value for correcting a detection shift of the synchronization detector when receiving a print request, and disables the function when receiving a color-shift correction request.

### Aspect 6

According to Aspect 6, in the color image forming apparatus of any one of Aspect 1 to Aspect 5, the color-shift correction value and the first light amount stored in the memory are updated at substantially the same timing.

### Aspect 7

According to Aspect 7, in the color image forming apparatus of any one of Aspect 1 to Aspect 6, the update unit includes: a light amount setting step that sets a light amount of the light emitter; a pattern forming step that forms a pattern for detecting a detection shift generated when a light amount of light incident on the synchronization detector fluctuates; and a pattern detecting step that detects the formed pattern, repeatedly performs the light amount setting step, the pattern forming step, and the pattern detecting step while changing the light amount, and calculates the detection-shift characteristic value based on a detection result of the pattern, and updates the detection-shift characteristic value stored in the memory.

### Aspect 8

According to Aspect 8, in the color image forming apparatus of Aspect 7, the pattern forming step and the pattern detecting step forms and detects the pattern using a pattern forming unit and a pattern detecting unit used when the color-shift correction function unit corrects a color shift.

### Aspect 9

According to Aspect 9, in the color image forming apparatus of Aspect 7, the pattern formed in the pattern forming step is common in all of an angle, a length, a width, and a formation interval as compared with a pattern formed by the color-shift correction function unit.

### Aspect 10

According to Aspect 10, the color image forming apparatus of any one of Aspect 1 to Aspect 9 further includes a replacement detector that detects whether the optical writing device has been replaced, in which when a power supply of the color image forming apparatus is turned on, the update unit operates when the replacement detector detects that the optical writing device is brand-new.

### Aspect 11

According to Aspect 11, in the color image forming apparatus of Aspect 10, when it is determined that the update unit has been normally terminated, the detection-shift characteristic value is updated, and notification of completion of update processing is provided so that the update unit does not operate when the power supply of the color image forming apparatus is turned on from next time.

### Aspect 12

According to Aspect 1, in the color image forming apparatus of any one of Aspect 1 to Aspect 11, the detection-shift characteristic value is stored in the memory in a tabular array, the detection shift correction function unit refers to the detection-shift characteristic value closest to the first light amount and the second light amount from the tabular array or performs interpolation processing to calculate two of the detection-shift characteristic values, and calculates the detection-shift correction value based on a difference between the two detection-shift characteristic values.

### Aspect 13

According to Aspect 13, in the color image forming apparatus of Aspect 12, the update unit operates the light emitter with three light amount settings to obtain multiple detection results of detection shifts and perform an interpolation processing of the detection-shift correction value to update the detection-shift characteristic value of each of the tabular array stored in the storage unit.

### Aspect 14

According to Aspect 14, in the color image forming apparatus of Aspect 12 or Aspect 13, the update unit performs linear interpolation processing of the detection-shift correction values of two neighboring points on a detection result of the detection shift.

### Aspect 15

According to Aspect 15, in the color image forming apparatus of any one of Aspect 1 to Aspect 11, the detection-shift characteristic value is stored in the memory as coefficients of an N-th order polynomial, the detection shift correction function unit calculates the detection-shift characteristic value corresponding to the first light amount and the second light amount using the coefficients of the N-th order polynomial, and calculates the detection-shift correction value from a difference between two of the detection-shift characteristic values.

### Aspect 16

According to Aspect 16, in the color image forming apparatus of Aspect 15, the update unit operates the light emitter with N+1 light amount settings to obtain a detection result of multiple detection shifts, calculates the coefficients of the N-th order polynomial based on a detection result of the multiple detection shifts, and updates the coefficients of each of the N-th order polynomials stored in the memory.

### Aspect 17

According to Aspect 17, in the color image forming apparatus of Aspect 15 or Aspect 16, the detection-shift characteristic value is stored in the memory as coefficients of a third-order polynomial or a fourth-order polynomial, and the detection shift correction function unit operates to calculate the detection-shift characteristic value corresponding to the first light amount and the second light amount using the coefficients of the third-order polynomial or the fourth-order polynomial, and to calculate the detection-shift correction value from a difference between two of the detection-shift characteristic values.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A color image forming apparatus comprising:
a photoconductor on which an image is formed;
an optical writing device to exposes the photoconductor with light,
the optical writing device including:
a light emitter to emit light;
a deflector including a multifaceted reflector rotationally driven to deflect the light emitted from the light emitter to scan the photoconductor with the light in a scanning direction;
a synchronization detector to detect a write start timing of the light to be irradiated onto the photoconductor from the deflector;
circuitry configured to:
control the light emitter to emit light;
correct a detection shift of the synchronization detector generated by a fluctuation of a light amount of the light incident on the synchronization detector; and
adjust the write start timing to correct a color shift;
a memory to store:
an execution result including a first light amount of the light emitter to correct the color shift;
a color-shift correction value to correct the color shift of each colors in the scanning direction; and
a detection-shift characteristic value indicating a characteristic of the detection shift;
wherein the circuitry is further configured to:
calculates a detection-shift correction value to correct the detection shift based on:
the first light amount;
a second light amount for emitting the light emitter as a lighting condition; and
the detection-shift characteristic value;
add the detection-shift correction value to a color-shift correction value to adjust the write start timing; and
update the detection-shift characteristic value stored in the memory.

2. The color image forming apparatus according to claim 1,
wherein the circuitry is further configured to:
control the light emitter to emit a constant light amount while the light emitter irradiating the light from one end to another end of a surface of the deflector scanning in the scanning direction.

3. The color image forming apparatus according to claim 1, further comprising:
multiple light emitters including the light emitter; and
multiple photoconductors including the photoconductor,
wherein the multiple light emitters respectively irradiate the multiple photoconductors, and
the optical writing device irradiates the synchronization detector with light emitted from the multiple light emitters.

4. The color image forming apparatus according to claim 1,
wherein the synchronization detector includes a slit to limit a light path of the light incident from the light emitter.

5. The color image forming apparatus according to claim 1,
wherein the circuitry is further configured to, among requests to operate the optical writing device:
enable calculating the detection-shift correction value to correct the detection shift in response to a receipt of a print request; and
disable the calculating the detection-shift correction value in response to a receipt of a request to correct the color shift.

6. The color image forming apparatus according to claim 1,
wherein the circuitry updates the color-shift correction value and the first light amount stored in the memory at a same timing.

7. The color image forming apparatus according to claim 1,
wherein the circuitry is further configured to, while changing the light amount, repeatedly perform:
setting a light amount of the light emitter;
forming a pattern to detect the detection shift; and
detecting the pattern to:
calculate the detection-shift characteristic value based on the pattern detected; and
update the detection-shift characteristic value stored in the memory.

8. The color image forming apparatus according to claim 7, further comprising a sensor to detect a pattern to correct the color shift,
wherein the circuitry is further configured to detect the pattern to detect the detection shift by the sensor.

9. The color image forming apparatus according to claim 7,
wherein the circuitry forms patterns for calculating the detection-shift characteristic value,
the patterns are common in:
an angle;
a length;
a width; and
a formation interval,
as compared with the pattern formed to correct the color shift.

10. The color image forming apparatus according to claim 1, further comprising:
a replacement detector to detect a replacement of the optical writing device,
wherein the circuitry is further configured to:
update the detection-shift characteristic value stored in the memory,
when a power supply of the color image forming apparatus is turned on; and
when the replacement detector detects the replacement of the optical writing device.

11. The color image forming apparatus according to claim 10, further comprising a display,
wherein the circuitry is further configured to:
update the detection-shift characteristic value; and
display a completion of updating the detection-shift characteristic value on the display.

12. The color image forming apparatus according to claim 1,
wherein the circuitry is further configured to:
store the detection-shift characteristic value in a tabular array in the memory;
calculate two detection-shift characteristic values by:
referring to the detection-shift characteristic value closest to the first light amount and the second light amount from the tabular array; or
performing interpolation processing; and
calculate the detection-shift correction value based on a difference between the two detection-shift characteristic values.

13. The color image forming apparatus according to claim 12,
wherein the circuitry is further configured to:
control the light emitter to emit the light at three light amount to obtain a detection result of multiple detection shifts including the detection shift while changing the light amount;
perform interpolation processing on the detection-shift correction value based on the detection result of the multiple detection shifts; and
update the detection-shift characteristic value in the tabular array stored in the memory.

14. The color image forming apparatus according to claim 12,
wherein the circuitry is further configured to perform a linear interpolation process to correct the detection-shift correction values of two neighboring points on a detection result of the detection shift.

15. The color image forming apparatus according to claim 1,
wherein the circuitry is further configured to:
store the detection-shift characteristic value in the memory as coefficients of an N-th order polynomial;
calculate the detection-shift characteristic value corresponding to each of the first light amount and the second light amount using the coefficients of the N-th order polynomial; and
calculate the detection-shift correction value from a difference between the detection-shift characteristic value corresponding to the first light amount and the detection-shift characteristic value corresponding to the second light amount.

16. The color image forming apparatus according to claim 15,
wherein the circuitry is further configured to:
control the light emitter to emit the light at N+1 light amount to obtain multiple detection shifts including the detection shift while changing the light amount at N+1 numbers of settings;
calculate the coefficients of the N-th order polynomial based on the multiple detection shifts; and
update the coefficients of each of the N-th order polynomial stored in the memory.

17. The color image forming apparatus according to claim 15,
wherein the circuitry is further configured to:
store the detection-shift characteristic value in the memory as coefficients of a third-order polynomial or a fourth-order polynomial;
calculate the detection-shift characteristic value corresponding to each of the first light amount and the second light amount using the coefficients of the third-order polynomial or the fourth-order polynomial; and
calculate the detection-shift correction value from a difference between the detection-shift characteristic value corresponding to the first light amount and the detection-shift characteristic values corresponding to the second light amount.
